(19) United States
(12) Patent Application Publication
(10) Pub. No.: US 2026/0171956 A1
(43) Pub. Date: Jun. 18, 2026

(54) FLOATING TORQUE TUBE TRACKER ASSEMBLY

(71) Applicant: NORIA ENERGY HOLDINGS, LLC, Sausalito, CA (US)

(72) Inventors: Alex MAYER, Mill Valley, CA (US); James RAIFORD, San Francisco, CA (US); Jason KING, San Francisco, CA (US); Becca SUCHOWER, Sausalito, CA (US)

(73) Assignee: NORA ENERGY HOLDINGS, LLC, Sausalito, CA (US)

(21) Appl. No.: 19/462,827

(22) Filed: Jan. 28, 2026

Related U.S. Application Data
(63) Continuation-in-part of application No. 18/940,342, filed on Nov. 7, 2024, now Pat. No. 12,573,980.

(51) Int. Cl. H02S 20/32; B63B 35/44

(52) U.S. Cl. CPC H02S 20/32; B63B 35/44; B63B 2035/4453

(57) ABSTRACT

A floating solar photovoltaic array torque tube tracker assembly, including: a plurality of floats; solar PV modules mounted on top of the plurality of floats; and a rotation control system for rotating the floats or torque tubes passing through the floats to tilt the solar PV modules in a direction to track movement of the sun.

### RELATED APPLICATION:

The present application is a Continuation-In-Part of U.S. patent application Ser. No. 18/940,342, filed Nov. 7, 2024, of same title, the entire disclosure of which is incorporated herein by reference in its entirety for all purposes.

### GOVERNMENT RIGHTS:

This invention was made with government support under DE-SC0021714 awarded by the U.S. Department of Energy. The government has certain rights in the invention.

### TECHNICAL FIELD:

The present invention relates to floating solar photovoltaic (PV) arrays.

### Background of the Invention:

Almost all (>99%) of the floating solar PV arrays currently installed around the world do not track the sun because of the lack of a cost-effective and technically viable solution. For existing floating solar PV arrays with solar tracking, the floats are separate structures from the tracking components (i.e.: the torque tubes). This type of separation is similar to the separation found in ground mounted systems in which the torque tubes are mounted onto piers in the ground.

It is generally desirable to provide a solar PV system in which the number of system components can be minimized. This is especially true in the case of floating solar PV arrays, since all of the components of floating systems must be moved to and assembled at the site and then installed on the water. In addition, previous systems'rigid, plastic floats were expensive to ship in volume. In the case of floating solar PV arrays, it would be desirable to provide a system in which components of the system operate to provide multiple functionalities. As will be shown, the present system meets this condition. For example, in preferred embodiments, the present system rotates its floats to function as torque tubes that position the solar PV modules to track the movement of the sun across the sky.

### SUMMARY OF THE INVENTION

In preferred embodiments, the present system provides a floating solar PV assembly having cylindrical pontoons or floating torque tubes that can be used to vary the tilt of solar panels mounted on top. In optional embodiments, motors are used to drive the rotation of the cylindrical pontoons or floating torque tubes via direct drives, drive shafts, a hybrid configuration of direct drives and drive shafts, belt or chain drives, or coupling rods. In another optional embodiment, ballast tubes are used to achieve the rotation; and a tracker control system is also provided.

In various embodiments, the rotation of the pontoons or floating torque tubes can be driven either by on-axis or off-axis rotational drive systems.

By using a cylindrical-shaped float or pontoon to both support the solar modules and act as their direction-pointing torque tube, the overall number of system parts is reduced. Simply put, the floats and the torque tube functions may be performed by only one device (i.e.: a rotating cylindrical-shaped float). An advantage of using one system component as both the system “float” and the system “torque tube” results in a minimal number of failure points, as well as a reduced shipping density.

Another advantage of the present system is that in one embodiment it has a small, packaged footprint since its pontoons can be deflated and flat-packed. This reduces shipping and project costs. Another advantage of the present system is that it follows the undulations of water bodies while also tracking the sun. This minimizes stress on the tracking components and improves the reliability of the system while ensuring that system energy production is maximized.

In one preferred embodiment, the torque tubes are floating cylinders. In another preferred embodiment, the torque tubes are more traditional torque tubes, being supported by cylindrical floating “donut” shaped floats. In yet another optional embodiment, the floats supporting the torque tubes may be rectangular. It is to be understood that the presently claimed invention encompasses all of these embodiments, without limitation.

For example, in one preferred embodiment, the present system provides a floating solar photovoltaic array torque tube tracker assembly, comprising:
a plurality of cylindrical-shaped floats;
solar PV modules mounted on top of the plurality of cylindrical-shaped floats; and
a rotation control system for rotating the cylindrical-shaped floats to tilt the solar PV modules in a direction to track movement of the sun.

In another preferred embodiment, the present system comprises a floating solar photovoltaic array torque tube tracker assembly, comprising:
a plurality of donut-shaped floats;
a plurality of torque tubes, wherein the torque tubes are supported by the donut-shaped floats;
solar PV modules mounted on top of the torque tubes; and
a rotation control system for rotating either the donut-shaped floats or the torque tubes to tilt the solar PV modules in a direction to track movement of the sun.

In another preferred embodiment, the present system comprises a floating solar photovoltaic array torque tube tracker assembly, comprising:
a plurality of rectangular floats;
a plurality of torque tubes, wherein the torque tubes are supported by the rectangular floats;
solar PV modules mounted on top of the torque tubes; and
a rotation control system for rotating the torque tubes to tilt the solar PV modules in a direction to track movement of the sun.

As is to be understood, the present invention therefore encompasses cylindrical-shaped, donut-shaped and even rectangular shaped floats. As a result, the present system more generally comprises a floating solar photovoltaic array torque tube tracker assembly, comprising:
a plurality of solar PV modules;
a plurality of torque tube assemblies; and
a rotation control system for rotating the torque tube assemblies to tilt the solar PV modules in a direction to track movement of the sun,
   wherein each torque tube assembly comprises one of:
at least one cylindrical-shaped float with at least one solar PV module mounted thereon, wherein the cylindrical-shaped float is rotated to function as a torque tube by the rotation control system, or
a torque tube with at least one solar PV module mounted thereon with at least one donut-shaped float supporting the torque tube, wherein the donut-shaped float or torque tube is rotated by the rotation control system, or
a torque tube with at least one solar PV module mounted thereon with at least one rectangular float supporting the torque tube, wherein the torque tube is rotated by the rotation control system.

In its various embodiments, the present system may also comprise cylindrical-shaped, donut-shaped or other shaped floats that are inflatable membrane structures, or are made from a blow-molded, injection-molded, or extruded thermoplastic.

In various embodiments, the cylindrical-shaped floats may be full cylinders or half-cylinders.

In optional embodiments, the cylindrical-shaped floats may be connected together parallel to one another using an external frame or other connectors to form a multi-sided polygon. For example, an eight-cylinder polygon can be created with eight floats such that two of its floats are in the water and two of its floats are positioned adjacent to the solar PV module for mounting.

In optional embodiments, the rotation control system may be direct drive mechanisms connected to each row of cylindrical-shaped floats or torque tubes. In other optional embodiments, a drive shaft is used to connect and rotate multiple rows of cylindrical-shaped floats or torque tubes in unison. It is to be understood that the presently claimed invention encompasses all hybrid embodiments that combine direct drives and drive shafts to rotate multiple rows of floats or torque tubes in unison.

In other optional embodiments, a belt or chain drive wrapped around a sprocket on each row of the cylindrical-shaped floats, thus connecting the plurality of cylindrical-shaped float rows together such that they rotate in unison. In other optional embodiments, the rotation control system may be a pair of connecting rods connected to different locations on each of the cylindrical-shaped floats. Lateral movement of these connecting rods in opposite directions causes the cylindrical-shaped floats to rotate in unison. In other optional embodiments, ballast systems may be used to rotate the floats.

Other systems that may be included in the present system include onshore (or floating, or both onshore and floating) motor systems for rotating the cylindrical-shaped floats or torque tubes. Mooring lines may be used for positioning the assembly at a constant location in the body of water, as well as for connecting a plurality of torque tubes together. Spherical bearings, universal joints, beam couplings or flexible shaft couplings may be used to connect floats or torque tubes that are positioned together in line with one another. Optional spacing beams may be inserted between adjacent cylindrical-shaped floats or torque tubes to maintain the spacing between adjacent rows of cylindrical-shaped floats and provide structure to the overall array.

In yet other embodiments, the present system provides a floating solar photovoltaic array torque tube tracker assembly, comprising:
a plurality of floats, wherein each float has a central longitudinal axis about which the float rotates, and wherein the plurality of floats are positioned such that their central longitudinal axes are parallel to one another;
at least one solar PV module mounted on top of each of plurality of floats; and
a rotation control system that simultaneously rotates the floats to simultaneously tilt the solar PV modules in a direction to track movement of the sun.

In optional embodiments, the rotation control system comprises tensioning systems on opposite sides of the plurality of floats. The advantage of this design approach is that it provides continuous smooth rotational movement.

In optional embodiments, the rotation control system may either be an on-axis or an off-axis rotational drive system.

In optional embodiments, a first tensioning system connected to one of the floats pulls on the float to simultaneously rotate the plurality of floats in a first direction; and a second tensioning system connected to another of the floats pulls on the float to simultaneously rotate the plurality of floats in a second direction. These tensioning systems may be elastic members, but may also be winches, pulleys, or other mechanical systems

In other embodiments, one or more connecting elements link together the plurality of floats such that they rotate together simultaneously; with a first tensioning system connected to a first float to cause the floats to rotate together in a first direction and a second tensioning system connected to a second float to cause the floats to rotate together in a second (i.e.: opposite) direction. These connecting elements spanning between the floats may be portions of a single driving arm or may be individual cables or elastic members spanning between each of the floats.

In optional embodiments, a positioning system may be connected to the connecting element to simultaneously rotate the plurality of floats. This positioning system may comprise a linear actuator that extends or retracts a beam that is connected to one end of the connecting element. Optionally, a tensioning system may be connected to one of the plurality of floats such that the tensioning system and the positioning system urge the plurality of floats to rotate in opposite directions.

In other optional embodiments, the present rotation control system may comprise:
a downwardly extending member extending below each float, and
a horizontally extending member connected to a plurality of the downwardly extending members, and
a motor or other drive system that rotates a first float, wherein rotation of the first float moves the horizontally extending member causing the plurality of floats to simultaneously rotate together.

In other preferred embodiments, each of the floats may have a cross-section that is elliptical or oval in shape and may have a flattened top surface adjacent to the solar PV module. This has the benefit of controlling the location of the center of buoyancy of the float relative to that of the center of mass of the combined float and PV module, making the system more stable and less resistant to tipping over. The floats may also be of different buoyancy optimized dimensions such that the float's center of mass remains directly above the float's center of buoyancy such that the float will not tend to tip over (i.e. no net moment).

In optional embodiments, each of the floats have a counterweight that moves the center of mass of the combined float and PV module. The counterweight may optionally be disposed within the float, connected to the outside of the float, or even positioned on the end of a beam extending downwardly from the bottom of the float. These counterweights stabilize the floats and resist them tipping over by controlling the location of the center of buoyancy of the float relative to that of the center of mass of the combined float and PV module.

In other optional embodiments, outriggers or buoys may be mounted to opposite sides of each of the PV modules or on opposite sides of each of the floats. These buoys prevent opposite sides of the PV modules from entering the water when the floats are rotated. These buoys also increase stability. They may also be mounted to opposite sides of a frame that is connected to the floats, such that a first buoy is submerged and a second buoy is lifted out of the water when the floats rotate. This also assists in preventing the floats from tilting too far in one direction or the other.

### BRIEF DESCRIPTION OF THE DRAWINGS

FIG. 1A is a simplified perspective view of the present assembly in a first position, showing solar PV modules mounted on top of cylindrical-shaped floats.

FIG. 1B corresponds to FIG. 1A, after the cylindrical-shaped floats have been rotated to a second position, thereby tilting the solar PV modules to track movement of the sun.

FIG. 2A is a simplified perspective view of a solar PV module mounted onto a half-cylinder float in a first position.

FIG. 2B corresponds to FIG. 2A, after the half cylinder-shaped float has been rotated to a second position, thereby tilting the solar PV module to track movement of the sun.

FIG. 3A is a simplified perspective view of a plurality of cylindrical-shaped floats being connected together into a six sided polygon, with a solar PV module mounted on top.

FIG. 3B corresponds to FIG. 3A, but is instead rotated to a second position, thereby tilting the solar PV module to track movement of the sun.

FIG. 4A is a simplified perspective view of the present assembly in a first position, showing solar PV modules mounted on top of donut-shaped floats, where a set of donut-shaped floats support a torque tube, with the torque tube supporting a solar PV module thereon.

FIG. 4B corresponds to FIG. 4A, after the donut-shaped floats or torque tube have been rotated to a second position, thereby tilting the solar PV modules to track movement of the sun.

FIG. 4C is a top plan view corresponding to FIGS. 4A and 4B.

FIG. 5A is a is a simplified perspective view of the present assembly in a first position, showing solar PV modules mounted on top of rectangular-shaped floats, where the pair of rectangular-shaped floats support a torque tube, with the torque tube supporting a solar PV module thereon.

FIG. 5B corresponds to FIG. 5A, after the torque tube has been rotated to a second position, thereby tilting the solar PV modules to track movement of the sun.

FIG. 6A is a top plan view corresponding to one of the cylindrical-shaped floats of FIG. 1A.

FIG. 6B is a top plan view of a pair of solar PV modules supported by a single cylindrical-shaped float.

FIG. 6C is a top plan view of four or more solar PV modules supported by a single cylindrical-shaped float.

FIG. 7A is a top plan view similar to FIG. 4A, with a single solar PV module positioned in a landscape orientation on each torque tube.

FIG. 7B is a top plan view similar to FIG. 7A, but with a pair of solar PV modules positioned in landscape orientation on each torque tube.

FIG. 7C is a top plan view similar to FIG. 7A, but with the solar PV modules instead being positioned in a portrait orientation.

FIG. 8A is a view similar to FIG. 1A, but adding a belt drive and coupling sprockets to rotate the cylindrical-shaped floats in unison.

FIG. 8B corresponds to FIG. 8A after the solar PV modules have been rotated into a second position.

FIG. 9A is a side elevation view of an alternate system with connecting rods for rotating a pair of floats in unison.

FIG. 9B corresponds to FIG. 9A, but after the floats have been rotated to a second position.

FIG. 10 is a top plan view of a floating solar PV array with floating motor systems and direct drive assemblies for rotating the floats.

FIG. 11 is similar to FIG. 10, but instead reduces the number of positioning motors by use of a drive shaft, connector shafts and gear boxes to rotate the floats in unison.

FIG. 12 is similar to FIG. 10 and FIG. 11, but uses a combination of direct drives and drive shafts for rotating the floats

FIG. 13 illustrates solar PV mounted onto a series of cylindrical-shaped floats, with ballast tubes connected under the cylindrical-shaped floats.

FIGS. 14A to 14D illustrate tilting the solar PV modules by changing the amount of water in the ballast tubes.

FIG. 15A illustrates a system for connecting cylindrical-shaped floats together end-to-end.

FIG. 15B illustrates a system for connecting torque tubes together end-to-end.

FIG. 16A is a side elevation view of a flexible joint for connecting the cylindrical-shaped floats of the solar array to an onshore positioning motor via a direct drive system.

FIG. 16B is similar to FIG. 16A, but the positioning motor moves up and down on a rail structure to fluctuations in water level.

FIG. 17A is a top plan view of a floating array that uses positioning motors powered by a solar PV module separate from the main array.

FIG. 17B is a top plan view of a floating array that uses power from the main array of floating solar PV modules to power positioning motors.

FIG. 18 is a top plan view of a floating solar PV array with parallel rows of torque tubes held in position by shore-to-shore mooring lines.

FIG. 19 is a close-up top plan view and side elevation view of a mooring line shackle connection to one of the torque tubes.

FIG. 20 is a top plan view of a floating solar PV array having structural beams connected to adjacent torque tubes, wherein the structural beams maintain the spacing between adjacent rows of torque tubes.

FIG. 21 is a close-up view of the connection between the structural beams and torque tubes in FIG. 20.

FIG. 22 is a top plan view of a floating solar PV array having structural beams connected to adjacent cylindrical-shaped floats, wherein the structural beams maintain the spacing between adjacent rows of floats.

FIG. 23A is a side elevation view of a float and PV module with elastic stabilizing, tensioning cables connected to opposite sides of the float.

FIG. 23B is similar to FIG. 23A, but shows the float rotated to pull on one of the tensioning cables.

FIG. 23C shows a series of floats with elastic tensioning cables connected at opposite ends of the series of floats.

FIG. 24A is a side elevation view of a series of floats connected together by a driving arm which is moved by a linear actuator.

FIG. 24B corresponds to FIG. 24A but with the floats instead rotated to a first position.

FIG. 25A is similar to FIG. 24A but adds a tensioning cable at an opposite end to the linear actuator.

FIG. 25B is similar to FIG. 25A but with the floats instead rotated to a first position.

FIG. 26A is a side elevation view of a series of floats connected together by a cable or connecting rod with a winch pulling on one side of the cable or connecting rod and a tensioning cable pulling on the opposite side of the cable or connecting rod.

FIG. 26B corresponds to FIG. 26A, but with the floats rotated together in a first direction.

FIG. 26C corresponds to FIG. 26A, but with the floats rotated together in a second direction.

FIG. 27A is a perspective view of an alternate positioning system using moving underwater bars for simultaneously rotating the plurality of floats.

FIG. 27B is a side elevation view corresponding to FIG. 27A.

FIG. 27C is a side elevation view corresponding to FIG. 27A, but with the floats rotated in a first direction.

FIG. 27D is a side elevation view corresponding to FIG. 27A, but with the floats rotated in a second direction.

FIG. 28A illustrates a circular float centered and then rotated to a first position.

FIG. 28B illustrates an elliptical float centered and then rotated to a first position.

FIG. 28C illustrates an elliptical float having a flattened top centered and then rotated to a first position.

FIG. 28D illustrates a float having a shape that is buoyancy optimized such that its center of mass remains directly above its center of buoyancy, thus being balanced at different angles to resist tipping over.

FIG. 29A is an elevational view illustrates two optional internal counterweights for the floats to lower the center of gravity of the combined float and PV module.

FIG. 29B is an elevational view of a counterweight mounted onto the exterior bottom of a float.

FIG. 29C is an elevational view of a counterweight positioned on the end of a beam extending downwardly from a float.

FIG. 30A illustrates a float and PV module with buoys mounted to opposite ends of the PV module in both a centered and tilted position.

FIG. 30B illustrates a float and PV module with buoys mounted to opposite sides of the float in both a centered and tilted position.

FIG. 30C illustrates a float and PV module with buoys mounted to opposite sides of a frame connected to the float in both a centered and tilted position.

FIG. 30D is similar to FIG. 30C, but the frame rotates together with the float.

FIG. 31 is an illustration of an on-axis rotational drive system for tilting the floats.

FIG. 32 is an illustration of a first off-axis rotational drive system for tilting the floats.

FIG. 33 is an illustration of a second off-axis rotational drive system for tilting the floats.

### DETAILED DESCRIPTION OF THE DRAWINGS

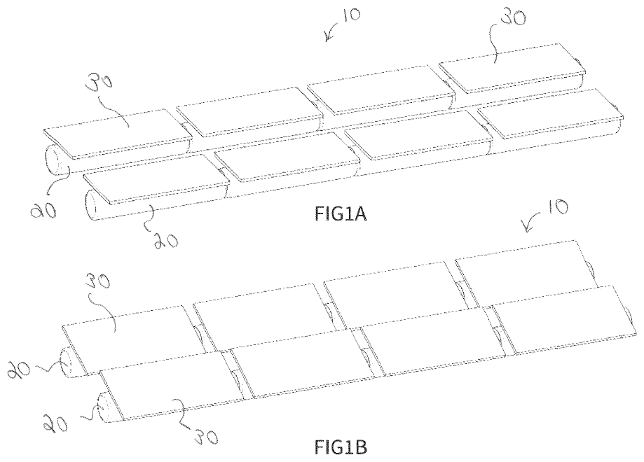

FIGS. 1A and 1B illustrate a floating solar photovoltaic array torque tube tracker assembly 10 formed from cylindrical floats 20 with solar PV modules 30 mounted on top. FIG. 1A shows the floats 20 in a first position such that PV modules 30 point in a first direction, and FIG. 1B shows the floats 20 rotated to a second position such that PV modules 30 point in a second direction. In accordance with the present system, floats 20 are rotated in unison such that PV modules 30 point in a direction that tracks the movement of the sun across the sky during the day. As such, assembly 10 preferably comprises: a plurality of cylindrical-shaped floats 20; solar PV modules 30 mounted on top of the plurality of cylindrical-shaped floats 20; and a rotation control system (to be explained further herein) for rotating cylindrical-shaped floats 20 to continuously tilt solar PV modules 30 in a direction to track movement of the sun.

In preferred embodiments, cylindrical-shaped floats 20 are inflatable membrane structures. The advantage of being inflatable is that they can be deflated for shipping and storage (thereby significantly decreasing shipping and installation costs). Alternatively, however, cylindrical-shaped floats 20 may instead are made from a blow-molded, injection-molded, or extruded thermoplastic.

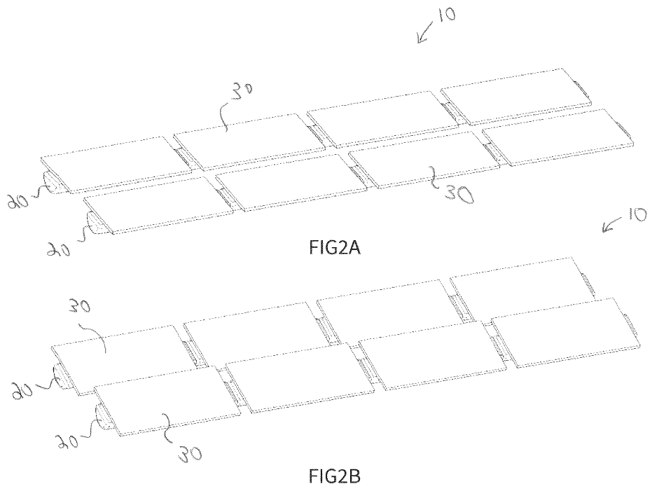

Next, FIGS. 2A and 2B show simplified views of solar PV modules 30 mounted onto half-cylinder floats 20 in a first position (FIG. 2A) and then rotated to a second position (FIG. 2B). It is to be understood that any reference to “cylindrical-shaped” herein refers to both full and half cylinders. Moreover, any reference to “cylindrical-shaped” herein may also refer to floats of any shape, having a curved surface which is able to rotate on the surface of the water, all keeping within the scope of the present invention. The advantage of this embodiment of float 20 is that it provides greater surface area onto which solar PV module 30 can be attached and reduces wind load by reducing exposed surface area on the backside of the panels.

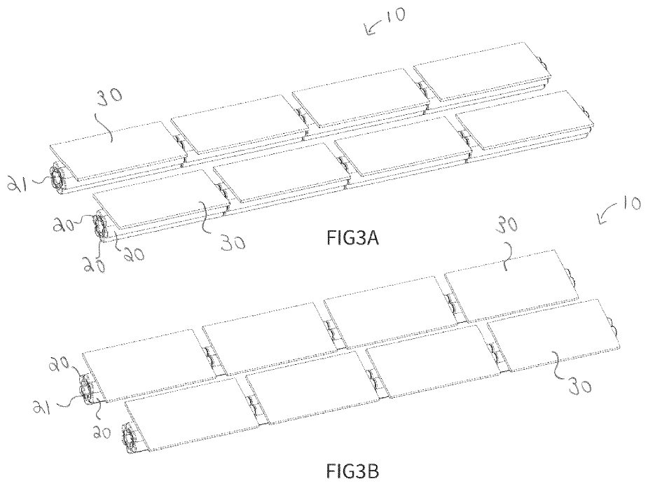

FIG. 3A is a simplified side elevation view of a plurality of cylindrical-shaped floats 20 being connected together by connection frame 21 into a six sided polygon, with a solar PV module 30 mounted on top. FIG. 3B corresponds to FIG. 3A, but is instead rotated to a second position. The advantage of this embodiment of the present system is that two or more floats 20 are in contact with the water and another two or more floats 20 are supporting solar PV module 30. This provides a more stable base for the PV array. In preferred embodiments, connection frame 21 can be made from any of metals, plastics, and reinforced plastics.

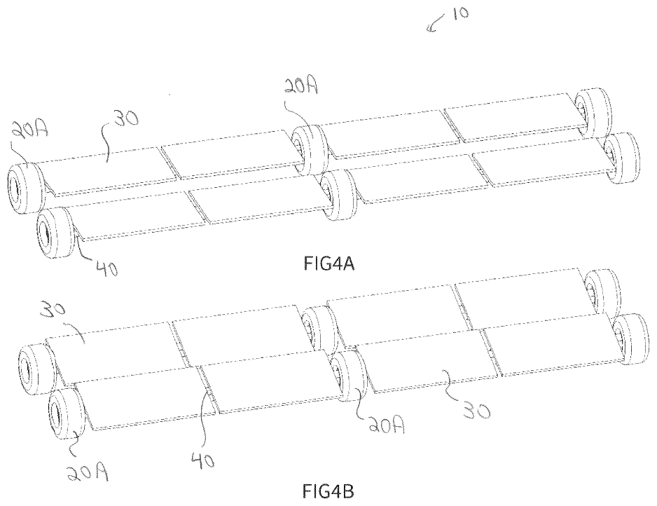

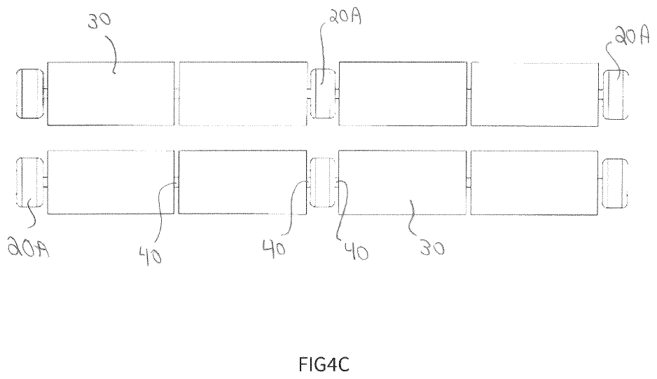

FIGS. 4A to 4C are simplified perspective and top views of an embodiment of the present system having a set of donut-shaped floats 20A that support a torque tube 40, with the torque tube supporting solar PV modules 30 thereon. Simply put, the donut-shaped floats 20A hold torque tube 40 out of the water. Rotation of donut-shaped floats 20A causes torque tube 40 to be rotated such that the direction that solar PV modules 30 point can be varied over the course of the day to track movement of the sun.

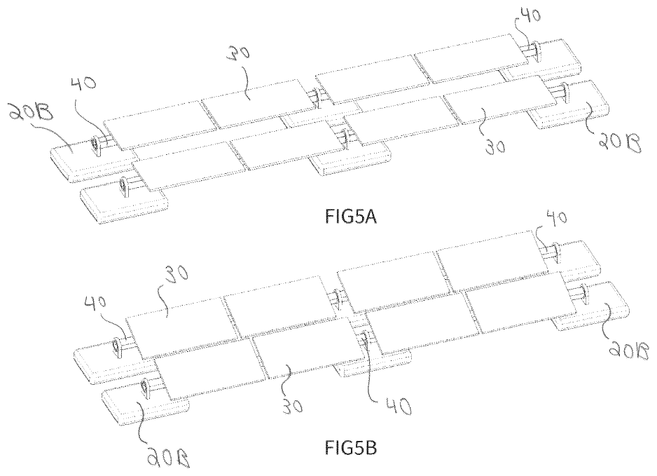

Next, as seen in FIGS. 5A and 5B, rectangular floats 20B may also be used to support torque tubes 40 thereon. The rotation of torque tubes 40 causes the angle of solar PV modules 30 to change, thereby following the movement of the sun over the course of the day. In preferred embodiments, torque tubes 40 can be made of metals (such as steel or aluminum), plastic or even bamboo. Torque tubes 40 can have circular or polygon cross sections as desired. Solar PV modules 30 may be attached to torque tubes 40 by rails with clamps or fasteners that grab onto the frame of the solar PV module.

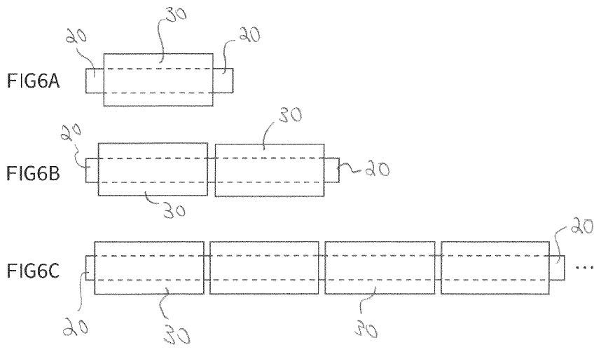

FIGS. 6A to 6C show that different numbers of solar PV modules 30 may be connected to each cylindrical-shaped float 20. For example, FIG. 6A shows one solar PV module connected to cylindrical-shaped float 20. FIG. 6B shows two solar PV modules connected to cylindrical-shaped float 20, and FIG. 6C shows four or more solar PV modules connected to cylindrical-shaped float 20.

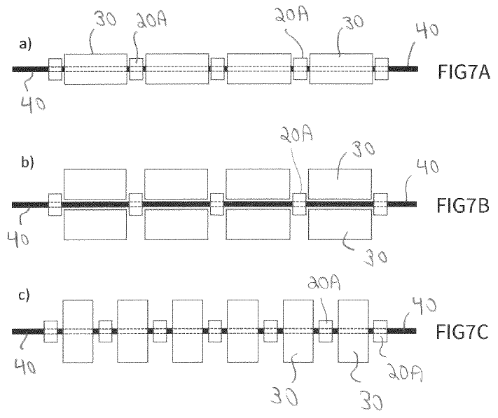

FIGS. 7A to 7C show that the solar PV modules can also be attached in different orientations to a torque tube 40 (or alternately to a cylindrical-shaped float 20). In FIG. 7A, solar PV modules 30 are positioned one by one in a landscape orientation on a torque tube 40. In FIG. 7B, solar PV modules 30 are positioned two in landscape orientation along a torque tube 40. The advantage of FIG. 7B compared to FIG. 7A is that it increases the solar capacity per length of torque tube 40 FIG. 7C is similar to FIG. 7A, but with the solar PV modules 30 instead being positioned one in portrait orientation between donut-shaped floats 20A along a torque tube 40.

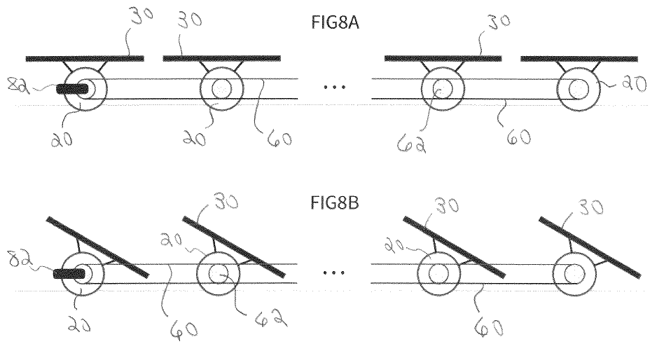

FIGS. 8A and 8B are similar to FIG. 1A, but adding a belt drive 60 and coupling sprockets 62 to rotate the cylindrical-shaped floats in unison. It is to be understood that the belt drive and sprockets may be made of any suitable material including plastics, reinforced plastics, metal chains, etc., all keeping within the scope of the present invention. The advantage of the present belt drive and sprocket rotation control system is that it rotates all of floats 20 together in unison (thereby keeping solar PV modules 30 all pointing in the same direction. A motor 82 may be used to rotate belt 60, thereby rotating all connected floats 20 together in unison. As will be shown, repeating units of this arrangement can be assembled together to successfully build a much larger floating solar PV array.

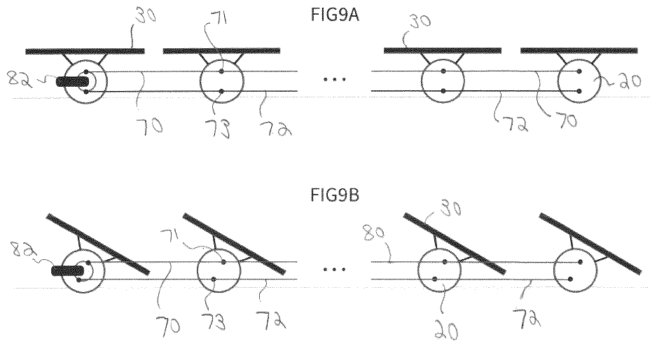

Next, FIGS. 9A and 9B illustrate an alternate rotation control system comprising a pair of connecting rods 70 and 72 connected to different locations (pins 71 and 73) on each of the cylindrical-shaped floats 20. As can be seen comparing FIGS. 9A and 9B, lateral movement of the connecting rods 70 and 72 in opposite directions causes rotation of the cylindrical-shaped floats 20 (and associated tilting of solar PV modules 30).

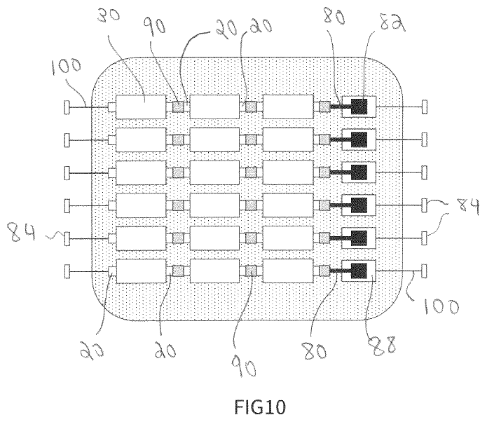

Next, FIG. 10 illustrates an embodiment of the present system in which assembly 10 uses a direct drive motor system for rotating the floats. Specifically, a plurality of parallel, connecting shafts 80 are provided. Each connecting shaft 80 runs between the end of a row of floats 20 and a floating positioning motor 82 at one end of the assembly in a direct drive configuration. The positioning motors 82 may also rotate torque tubes 40 in the same direct drive configuration. In this embodiment, each positioning motor 82 rests on its own dedicated motor float 88. As illustrated, the array may cover a reservoir such that mooring lines 100 attached to the array are connected to shore piles or anchors 84 on opposite sides of a reservoir. Positioning motors 82 each rotate a row of floats 20. Connections 90 between floats 20 make all the floats 20 in a row rotate in unison.

Next, FIG. 11 illustrates another method for rotating multiple rows of floats in unison. In this embodiment, a drive shaft 86 is connected to multiple connecting shafts 80 via gear boxes 89. In this configuration, a single positioning motor 82 is able to simultaneously rotate multiple rows of floats 20 via the drive shaft 86. Drive shafts 86 may comprise any form of solid or hollow tube or belt or chain drive and may be made of metals, plastics or reinforced plastics. This embodiment reduces the number of positioning motors 82 needed to rotate multiple rows of floats 20 in unison.

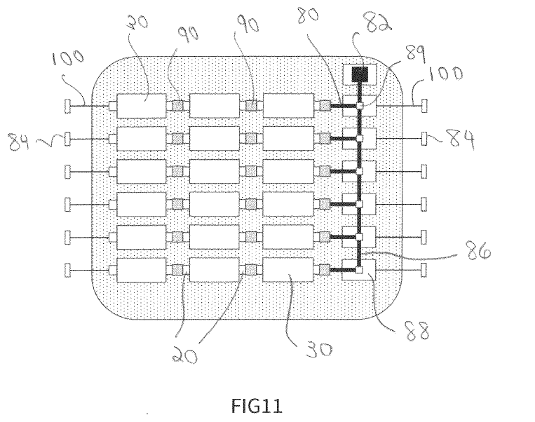

Next, FIG. 12 illustrates a hybrid system of FIG. 10 and FIG. 11 in which a floating positioning motor 82 rotates multiple rows of floats 20. In this embodiment, each positioning motors 82 is used to rotate one row of floats 20 in a direct drive configuration; however, there is also a drive shaft 86 associated with each positioning motor 82 that translates the rotation to adjacent rows of floats 20 via connecting shafts 80 and gear boxes 89. This embodiment uses more motors than that of FIG. 11, but it has the advantage of transmitting torque from the positioning motors 82 over shorter distances to rotate multiple rows of floats 20 in unison.

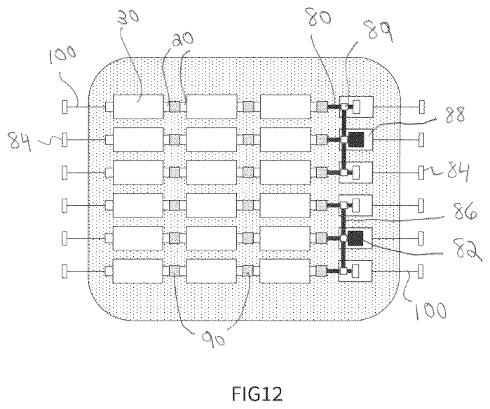

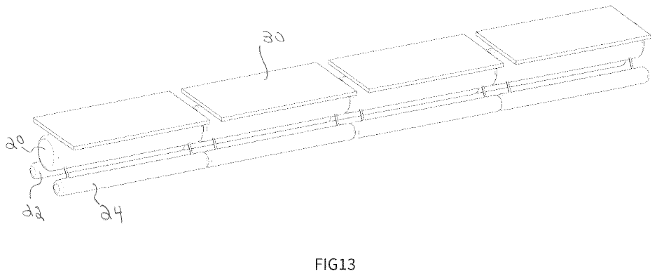

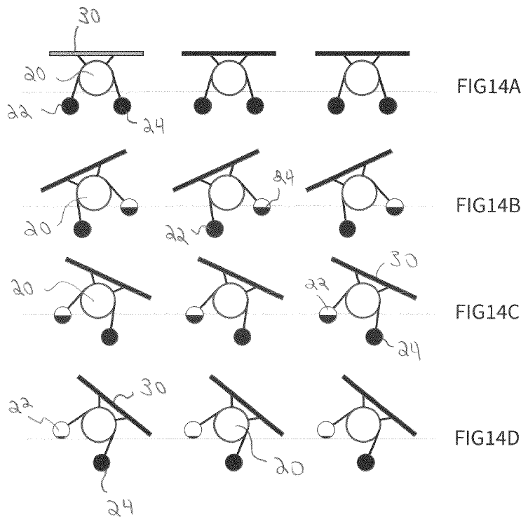

Next, FIGS. 13 to 14D illustrates a system having ballast tubes 22 and 24 connected to the bottom of each cylindrical-shaped float 20. As seen in FIG. 14A, ballast tubes 22 and 24 may both be filled equally with water (thereby pointing solar PV modules 30 directly upwards. As seen in FIG. 14B, ballast tubes 22 may be filled with more water than ballast tubes 24 causing the array to tilt in one direction. As seen in FIG. 14C, ballast tubes 24 may instead be filled with more water than ballast tubes 22, thereby causing the array to tilt in the opposite direction. As can be seen by comparing FIGS. 14C and 14D, varying the amount of water used to partially fill one side of ballast tubes can be used to control the tilt angle of the solar PV modules 30.

As seen in FIGS. 15A and 15B, a variety of different systems may be provided for connecting torque tubes 40 (or cylindrical-shaped floats 20) together end-to-end. These connectors 90 include spherical bearings, universal joints, beam couplings or flexible shaft couplings. These systems may be combined and other systems may be used instead, all keeping within the scope of the present invention.

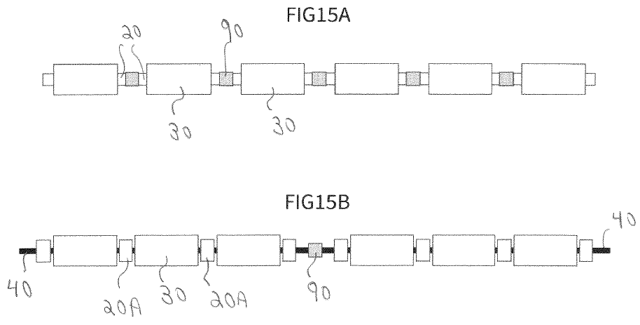

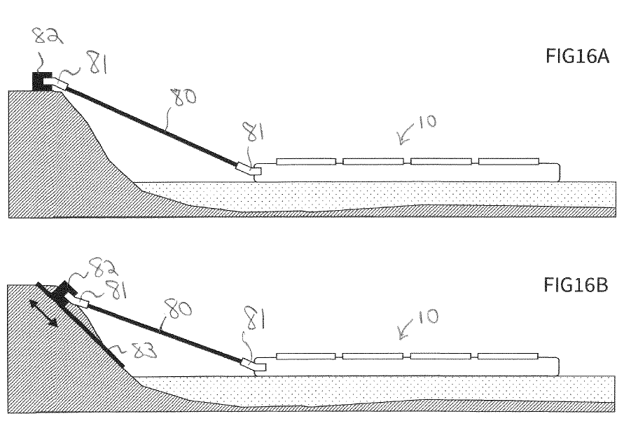

FIG. 16 illustrates side elevation views of a flexible joint 81 for connecting rows of floats 20 in the solar array to an onshore positioning motor 82 via a connecting shaft 80. In FIG. 16B, positioning motor 82 moves up and down on a rail 83. The flexible joints 81 in this embodiment accommodate changes in water level for systems where the positioning motors 82 are located onshore.

The positioning motors 82 can be powered by its own dedicated solar PV modules 31 separate from the main array as in FIG. 17A or by one or a larger string of floating solar PV modules 30 of the main array as in FIG. 17B.

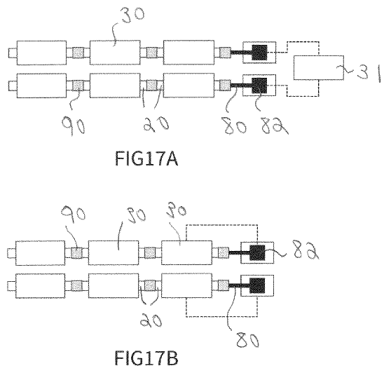

The present system also includes a number of different mooring and grid structures, as follows. For example, FIGS. 18 and 19 illustrate the use of mooring lines 100 passing across the assembly from one shore of the reservoir to the other. Mooring lines 100 extend in a direction perpendicular to torque tubes 40. In preferred embodiments, mooring lines 100 are connected to opposite sides of shackle 102, and torque tube 40 rotates within an opening passing through shackle 102. As illustrated, FIG. 18 uses rotating torque tubes 40 supported by donut-shaped floats 20A, whereas FIGS. 10 to 17B used rotating floats 20. It is to be understood that these embodiments are interchangeable and that the systems illustrated in FIGS. 10 to 22 may be used with either the cylindrical-shaped floats 20 embodiment, the rectangular floats 20B and torque tubes 40 embodiment, or the donut-shaped floats 20A and torque tubes 40 embodiment of the present system.

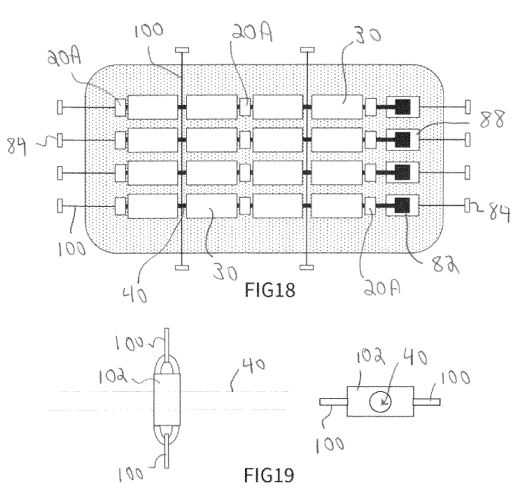

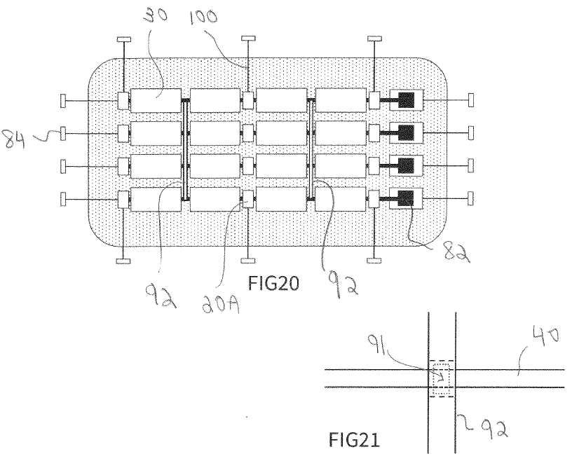

Next, FIGS. 20 and 21 illustrate a system in which structural beams 92 are used to separate and align successive rows of torque tubes 40, thereby keeping the entire array in alignment and providing structural stability. FIG. 21 shows an optional bearing 91 that permits each torque tube 40 to rotate in the openings passing through structural beams 92.

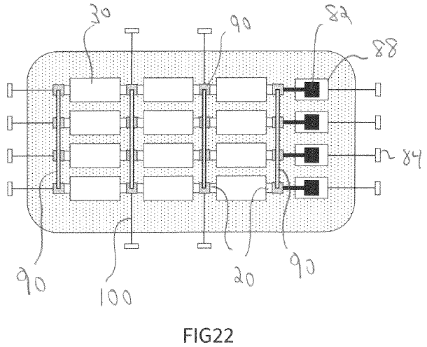

FIG. 22 is similar to FIG. 21, but instead uses floats 20. It is to be understood that spacing systems between adjacent rows of solar PV modules 30 may be connected to cylindrical-shaped floats 20, donut-shaped floats 20A, rectangular shaped floats 20B, other shaped floats, torque tubes 40, or some combination thereof, all keeping within the scope of the present system.

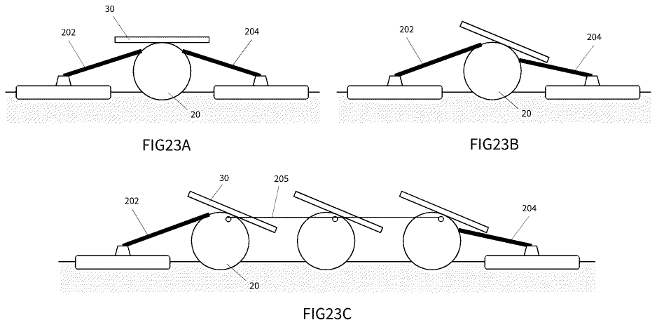

FIG. 23A is a perspective view of a float 20 and PV module 30 with pairs of elastic stabilizing, tensioning cables 202 and 204 connected to opposite sides of float 20. At rest, the tension can be the same in cables 202 and 204 such that float 20 is rotated to a position where PV module 30 faces upwardly as shown. FIG. 23B is similar to FIG. 23A, but shows the float rotated. At this time, cables 202 are under more tension than cables 204. As can be appreciated, cables 202 and 204 work together to keep PV module 30 facing upwards unless overcome by the power of the present positioning system to rotate the floats 20 to other desired positions, as will be explained. As can be appreciated, by providing this sort of resistance, cables 202 and 204 can gently counteract the forces of the present positioning system's drive motor such that smooth controlled positioning can be achieved.

FIG. 23C shows a series of floats 20 with similar elastic tensioning cables 202 and 204 connected at opposite ends to the series of floats. A series of non-elastic cables or members 205 can be connected to span between all of the floats 20. One long member or cable 205 can be used. Alternatively, sections of cable or individual short members 205 can be connected to span between each of the floats, all keeping within the scope of the present invention. As can be seen, cables 202 and cables 204 will urge all of the floats 20 to rotate together in one direction or another (with cable or member 205 causing the floats to rotate together in unison). When the system is at rest and the cable tensions are balanced, PV panels 30 may point straight upwardly. Alternatively, the PV modules 30 may be positioned to point at another desired angle when the tensions in cables 202 and 204 are unbalanced.

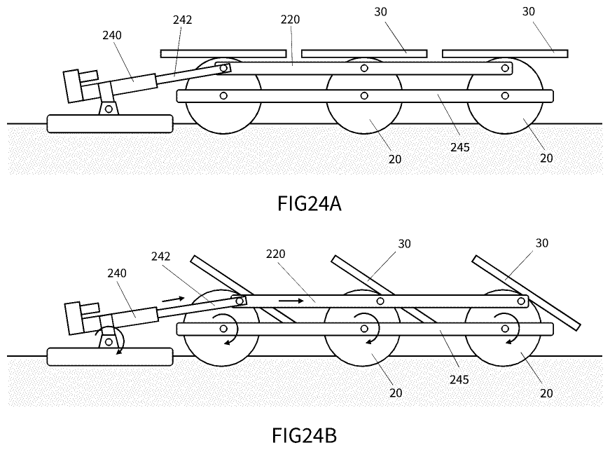

FIG. 24A is a side elevation view of a series of floats 20 connected together by a driving arm 220 which is moved by a linear actuator 240. The linear actuator 240 may be positioned on a hinge as illustrated to move beam 242 in and out. Linear actuator 240 may also be positioned on its own dedicated float as shown. When linear actuator 240 extends beam 242 to the position shown in FIG. 24B, it pushes on driving arm 220 which causes floats 20 to rotate in unison to change the angle of PV floats 30 to the sun. A frame 245 positions each of floats 20 a uniform distance apart. Floats 20 are rotatably connected to frame 245.

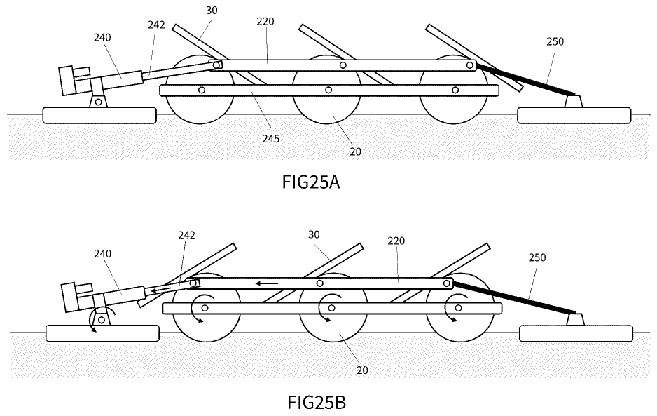

FIG. 25A is similar to FIG. 24A but adds a tensioning cable 250 at an opposite end of the frame than the linear actuator 240. In this embodiment, tensioning cable 250 can initially be set in the relaxed position of FIG. 25A. Next, as linear actuator 220 retracts beam 242, the floats 20 will rotate as shown, pulling on tension member 250. The stretching in tension member 250 helps to stabilize the system and helps smoothly return the system to the orientation of FIG. 25A when beam 242 is again extended.

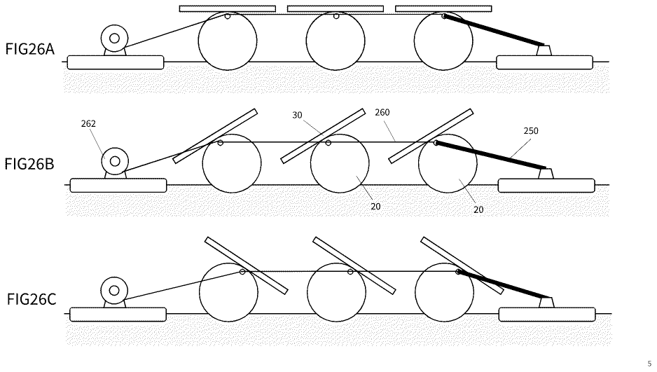

FIGS. 26A to 26C are similar to FIGS. 25A and 25B. Specifically, a tensioning member 250 such as stretched elastic is again used. However, in this embodiment, driving arm 220 has been replaced with a cable 260 spanning between floats 20. A winch 262 is used to pull on cable 260. As can be seen, winch 262 can pull/retract cable 260 a greater distance to rotate floats 20 and PV modules 30 to the position shown in FIG. 26B (thereby stretching tensioning cable 250). Conversely, winch 262 can release/extend cable 260 (which is then pulled by tensioning cable 250) returning the position of FIG. 26A. If even more cable 260 is released by winch 262, the tensioning cable 250 can pull on the floats 20 to rotate them to the position shown in FIG. 26C. In short, FIG. 26A is a side elevation view of a series of floats connected together by a cable or connecting rod 260 with a winch 262 pulling on one side of the cable or connecting rod and a tensioning cable 250 pulling on the opposite side of the cable or connecting rod. Together, the winch 260 and the tensioning cable 250 ensure smooth controlled rotational movement of floats 20.

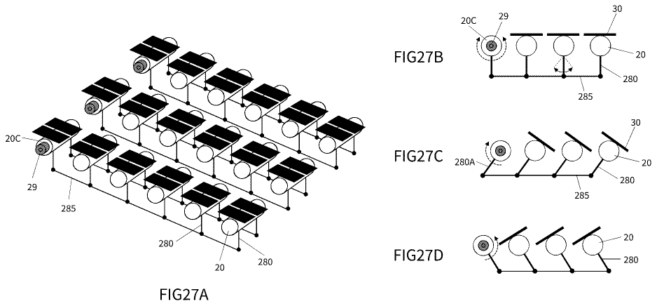

FIG. 27A is a perspective view of an alternate positioning system for simultaneously rotating the plurality of floats. In this system, each float 20 has a downwardly extending vertical member 280 attached thereto. The bottom ends of the vertical members 280 are all connected to a horizontal member 285. FIGS. 27A and 27B show the system initially at rest. The weight of horizontal member 285 will cause the vertical members 280 to point straight down as shown. Next, as seen in FIG. 27C, one float 20C can be rotated by motor or slew drive 29. The rotation of float 20C will rotate its vertical member 280A, pulling on (and slightly lifting) horizontal member 285. This will cause all of the floats 20 to rotate simultaneously in the same direction. Conversely, motor or slew drive 29 can rotate in the opposite direction to cause the floats 20 and PV modules 30 to rotate to the position shown in FIG. 27D. It is to be understood that different positioning systems can be used to move float 20C including, but not limited to, all of the positioning systems disclosed herein.

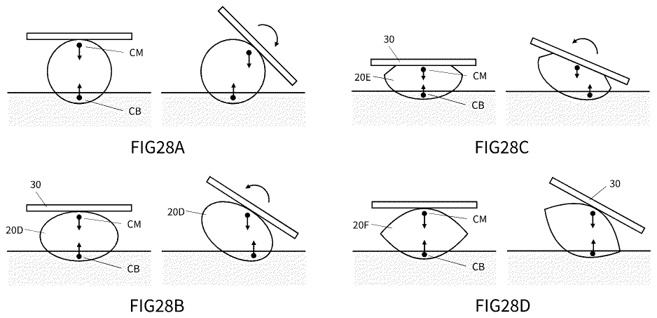

The present system also provides novel cross-sectional shapes for rotating floats 20. First, FIG. 28A illustrates a circular float centered and then rotated to a first position as previously disclosed herein. FIG. 28B illustrates a novel elliptical or oval float 20D centered and then rotated to a first position. The advantage of elliptical or oval float 20D as compared to circular floats 20 disclosed herein is that elliptical or oval float 20D helps control the location of the center of buoyancy of the float relative to that of the center of mass of the combined float and PV module, making it more resistant to tipping over (and thus more stable on the water). Specifically, the center of buoyancy CB is positioned outside the center of mass CM in FIG. 28B as compared to FIG. 28A, making the elliptical or oval embodiment more resistant to tipping over. FIG. 28C illustrates an elliptical or oval float 20E having a flattened top centered and then rotated to a first position. The advantage of having a flattened top (shown adjacent to PV module 30) is that the flat surface makes it easier to mount the PV module. FIG. 28D illustrates a float 20F with a buoyancy optimized design. In this embodiment, the center of mass CM remains positioned directly over, or close to directly over, the center of buoyancy CB of the float throughout its rotation. This prevents a “tipping over” moment from forming. It is to be understood that the specific shapes of floats 20D, 20E and 20F will depend upon the relative weights and dimensions of the system. Furthermore, the present buoyancy optimized shaped float 20F may only be buoyancy optimized through a specific angle of rotation, all keeping within the scope of the present invention.

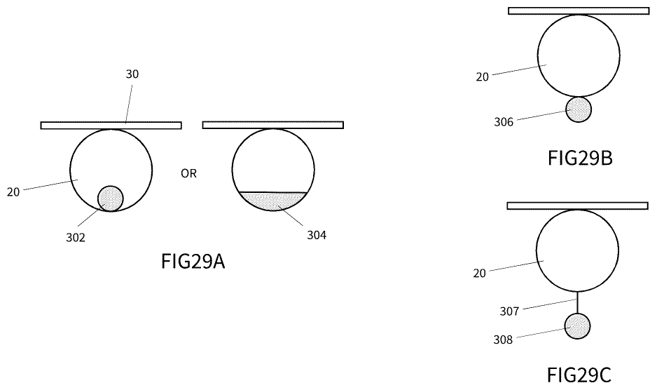

The present system also provides novel counterweight systems for floats 20 to make the floats more resistant to tipping over (and thus more stable on the water). First, FIG. 29A is an elevation view that illustrates two optional internal counterweights 302 or 304 for the floats to lower the center of gravity of the combined float and PV module, helping to control the location of the center of buoyancy of the float relative to that of the center of mass of the combined float and PV module. Counterweight 302 is positioned within float 20 and can be a solid structure or tube filled with material such water or sand. Counterweight 304 can simply be a concrete-filled portion of float 20. FIG. 29B is an elevational view of another counterweight 306 that is mounted onto the exterior bottom of float 20. FIG. 29C is an elevational view of another counterweight 308 positioned on the end of a beam 307 extending downwardly from float 20. All of these counterweights have the benefit of adding mass to the float opposite of the PV module helping to stabilize it during its rotation. In short, these novel counterweights add a “righting” moment to the system that keeps the PV modules 30 facing upwards. The present counterweights can comprise metal (e.g.: steel) tubes, concrete, tubes filled with sand or water, or other heavy objects. They can optionally extend along the entire length of the float or be positioned at discrete locations along its length, as desired.

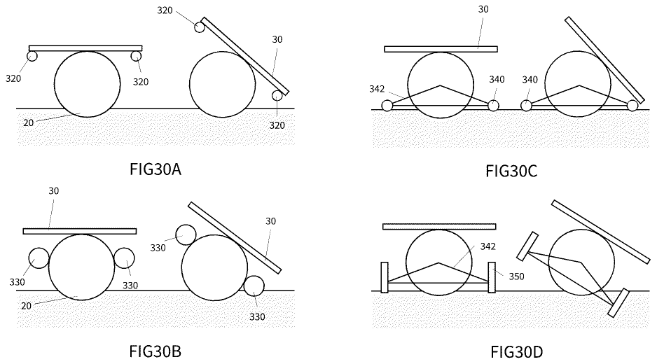

The present system also includes novel outrigger floats or “buoys” that prevent the ends of the PV modules from accidently tipping into the water. FIG. 30A illustrates a float 20 and PV module 30 with buoys 320 mounted to opposite ends of the PV module 30 in both a centered and tilted position. FIG. 30B illustrates a float 20 and PV module 30 with buoys 330 mounted to opposite sides of the float in both a centered and tilted position. In operation, buoys 320 and 330 contact the water if the float 20 rotates too far to either side so as to prevent the ends of PV module 30 contacting the water.

FIG. 30C illustrates a float and PV module with buoys 340 mounted to opposite sides of a frame 342 connected to float 20 in both a centered and tilted position. In this embodiment, the buoys 340 contact the ends of the PV module 30 should it rotate too far. This keeps the ends of PV module 30 out of the water. FIG. 30D is similar to FIG. 30C, but the frame 342 rotates together with float 20. In this embodiment, rotation of the float 20 causes one buoy 350 to be submerged and simultaneously lifts the opposite buoy 350 out of the water. This causes a moment opposite to the rotation of the float, tending to resist such rotation (thereby preventing one of the opposite ends of PV module 30 from dipping into the water).

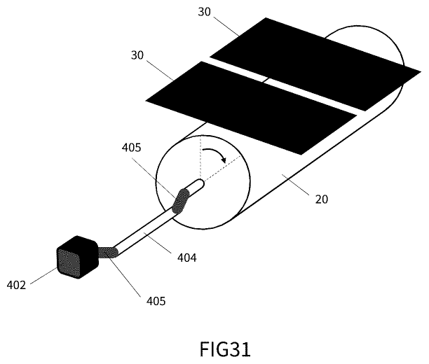

FIG. 31 is an illustration of an on-axis rotational drive system 400 for tilting a pair of floats 20. In this embodiment, a motor or slew drive 402 is connected to a connecting rod or shaft 404 for rotating floats 20. A universal joint 405 (at both ends of shaft 404) permits some flexibility to accommodate the movement of the PV array on the water.

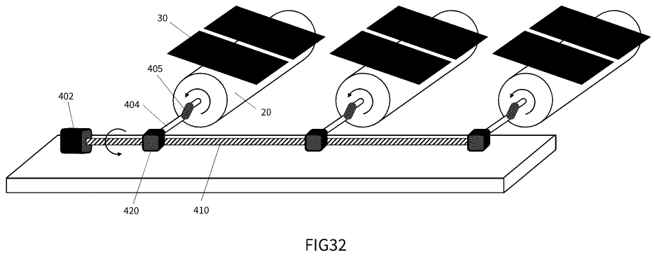

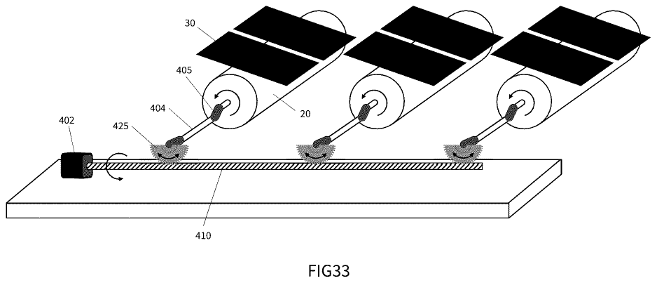

FIG. 32 is an illustration of a first off-axis rotational drive system for tilting the floats. In this embodiment, motor or slew drive 402 is connected to a connecting rod or shaft 410 which connects to gearboxes 420 which are connected to floats 20 by shafts 404 through universal joints 405.

FIG. 33 is an illustration of a second off-axis rotational drive system for tilting the floats. FIG. 33 shows an embodiment similar to FIG. 32, but the gearboxes are replaced by plates 425 with gear teeth. As shaft 410 is rotated, plates 425 are rotated, thereby rotating shafts 404 and floats 20.

What is claimed is:

1. A floating solar photovoltaic array torque tube tracker assembly, comprising:
a plurality of floats, wherein each float has a central longitudinal axis about which the float rotates, and wherein the plurality of floats are positioned such that their central longitudinal axes are parallel to one another;
at least one solar PV module mounted on top of each of plurality of floats; and
a rotation control system that simultaneously rotates the floats to simultaneously tilt the solar PV modules in a direction to track movement of the sun.

2. The assembly of claim 1, wherein the rotation control system comprises tensioning systems, elastics, winches, or pulleys on opposite sides of the plurality of floats.

3. The assembly of claim 1, wherein the rotation control system comprises an off-axis rotational drive system.

4. The assembly of claim 1, further comprising:
a first tensioning system connected to the float, wherein the first tensioning system pulls on the float to rotate in a first direction; and
a second tensioning system connected to the float, wherein the second tensioning system pulls on the float to rotate in a second direction opposite to the first direction.

5. The assembly of claim 4, wherein the first and second tensioning systems are elastic members.

6. The assembly of claim 1, further comprising:
a series of connecting elements linking together the plurality of floats such that the plurality of floats rotate together simultaneously;
a first tensioning system connected to a first float, wherein the first tensioning system pulls on the first float to simultaneously rotate the plurality of floats in a first direction; and
a second tensioning system connected to a second float, wherein the second tensioning system pulls on the second float to simultaneously rotate the plurality of floats in a second direction opposite to the first direction.

7. The assembly of claim 6, wherein the connecting elements comprise portions of a single driving arm.

8. The assembly of claim 6, wherein the connecting elements comprise cables or elastic members spanning between each of the floats.

9. The assembly of claim 1, further comprising:
a connecting element linking together the plurality of floats such that the plurality of floats rotate together simultaneously; and
a positioning system connected to the connecting element, wherein the positioning system moves:
(a) in a first direction to simultaneously rotate the plurality of floats in a first direction, and
(b) in a second direction to simultaneously rotate the plurality of floats in a second direction opposite to the first direction.

10. The assembly of claim 9, wherein the positioning system is a linear actuator.

11. The assembly of claim 9, further comprising:
a tensioning system connected to one of the plurality of floats, wherein the tensioning system and the positioning system urge the plurality of floats to rotate in opposite directions.

12. The assembly of claim 1, wherein the rotation control system comprises:
a downwardly extending member extending below each float, and
a horizontally extending member connected to a plurality of the downwardly extending members, and
a motor that rotates a first float, wherein rotation of the first float moves the horizontally extending member causing the plurality of floats to simultaneously rotate together.

13. The assembly of claim 1, wherein the floats have a cross-section that is elliptical or oval in shape.

14. The assembly of claim 13, wherein the elliptical or oval shaped float has a flattened top surface adjacent to the solar PV module.

15. The assembly of claim 1, further comprising a counterweight on each float, and wherein the counterweight moves the center of mass of the combined float and PV module.

16. The assembly of claim 15, wherein the counterweight is disposed within the float.

17. The assembly of claim 15, wherein the counterweight is connected to the outside of the float.

18. The assembly of claim 17, wherein the counterweight is positioned on the end of a beam extending downwardly from the float.

19. The assembly of claim 1, further comprising:
buoys mounted to opposite sides of each of the PV modules, or
buoys mounted to opposite sides of each of the floats, wherein the buoys prevent opposite sides of the PV modules from entering the water when the floats are rotated.

20. The assembly of claim 1, further comprising:
buoys mounted to opposite sides of a frame connected to the floats, wherein a first buoy is submerged, and a second buoy is lifted out of the water when the floats rotate.
